(19) United States
(12) Patent Application Publication
(10) Pub. No.: US 2006/0006805 A1
(43) Pub. Date: Jan. 12, 2006

(54) Flat lamp

(75) Inventors: Seung-hyun Son, Gyeonggi-do (KR); Young-mo Kim, Gyeonggi-do (KR); Seong-eui Lee, Gyeonggi-do (KR); Hyoung-bin Park, Gyeonggi-do (KR); Gi-young Kim, Gyeonggi-do (KR); Hidekazu Hatanaka, Gyeonggi-do (KR); Sang-hun Jang, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Corning Co., Ltd., Gyeonggi-do (KR)

(21) Appl. No.: 11/069,974

(22) Filed: Mar. 3, 2005

(30) Foreign Application Priority Data
Jul. 8, 2004 (KR) 10-2004-0052986

(51) Int. Cl. H01J 11/00; H01J 61/06; H01J 65/00

(52) U.S. Cl. 313/607

(57) ABSTRACT

Provided is a flat lamp including a lower panel and an upper panel arranged to face each other and forming a discharge space therebetween, a plurality of discharge electrodes formed at least one of the lower and upper panels, and a plurality of auxiliary electrodes formed on a panel where the discharge electrodes are formed and generating a start discharge by a voltage induced in the auxiliary electrode by a voltage is applied to the discharge electrodes.

### BACKGROUND OF THE INVENTION

Priority is claimed to Korean Patent Application No. 10-2004-0052986, filed on Jul. 8, 2004, in the Korean Intellectual Property Office, the disclosure of which is incorporated herein in its entirety by reference.

1. Field of the Invention

The present invention relates to a flat lamp, and more particularly, to a flat lamp that can lower a discharge voltage and improve luminance efficiency.

2. Description of the Related Art

Flat lamps used as backlights for LCDs have been developed from an edge-light type or direct-light type flat lamp using a cold cathode fluorescent lamp to a surface discharge type or facing discharge type flat lamp in which the entire lower portion of a light emitting surface is used as a discharge space, in consideration of a luminance efficiency and uniformity in brightness.

Although the surface charge type flat lamp is advantageous in that it exhibits a stable discharge property compared to the facing discharge type flat lamp, the overall brightness of the surface charge type flat lamp is lower than that of the facing discharge type.

FIG. 1 is a perspective view showing part of a conventional surface discharge type flat lamp. Referring to FIG. 1, a lower substrate 10 and an upper substrate 20 are arranged to face each other by being separated at a predetermined distance by spacers 14. A discharge space where plasma discharge is generated is formed between the lower substrate 10 and the upper substrate 20. The discharge space is filled with a discharge gas that is a mixture of neon (Ne) gas and xenon (Xe) gas.

A fluorescent layer 30 which is excited by ultraviolet rays generated during discharge and generates visible light is formed on interior surfaces of the lower substrate 10 and the upper substrate 20 and both side surfaces of the spacers 14. A plurality of discharge electrodes for generating a plasma discharge is formed on the lower substrate 10 and the upper substrate 20. In detail, a plurality of first and second lower electrodes 12a and 12b and first and second upper electrodes 22a and 22b are formed in pairs on exterior surfaces of the lower substrate 10 and the upper substrate 20, respectively. The same voltage is applied to the first lower electrode 12a and the first upper electrode 22a so that discharge is not induced therebetween. Also, the same voltage is applied to the second lower electrode 12b and the second upper electrode 22b so that discharge is not induced therebetween. Meanwhile, a predetermined difference in electric potential exists between the first lower electrode 12a and the second lower electrode 12b and between the first upper electrode 22a and the second upper electrode 22b, so that a surface discharge is induced in a direction parallel to the lower substrate 10 or the upper substrate 20.

In the flat lamp configured as above, although the luminance efficiency may be improved by increasing a partial pressure of the xenon gas or an absolute pressure of the discharge gas, a discharge voltage increases accordingly. Also, although the luminance efficiency may be improved by increasing a width between the electrodes to extend a discharge path, the discharge voltage increases as well in this case.

### SUMMARY OF THE INVENTION

To solve the above and/or other problems, the present invention provides a flat lamp that can lower a discharge voltage and improve a luminance efficiency.

According to an aspect of the present invention, a flat lamp comprises a lower panel and an upper panel arranged to face each other and forming a discharge space therebetween, a plurality of discharge electrodes located on at least one of the lower and upper panels, and a plurality of auxiliary electrodes located on a panel where the discharge electrodes are located and positioned such that a start discharge is generated by a voltage induced in the auxiliary electrodes by a voltage applied to the discharge electrodes.

A dielectric layer can be located between the discharge electrodes and the auxiliary electrodes.

The discharge electrodes can be located in pairs parallel to each other and the auxiliary electrodes can be located in pairs parallel to each other and corresponding to the discharge electrodes. The auxiliary electrodes are located in a direction parallel to the discharge electrodes.

A distance between the auxiliary electrodes can be less than a distance between the discharge electrodes.

A plurality of spacers can be located between the lower and upper panels to maintain a uniform distance therebetween.

A fluorescent layer can be located on an interior wall of the discharge space. The discharge space is filled with a discharge gas including xenon (Xe) gas.

According to another aspect of the present invention, a flat lamp comprises a lower substrate and an upper substrate arranged to face each other and forming a discharge space therebetween, a dielectric layer located on an outer surface of at least one of the lower and upper substrates, a plurality of discharge electrodes located on a surface of the dielectric layer, and a plurality of auxiliary electrodes located on the outer surface of a substrate where the discharge electrodes are located and embedded in the dielectric layer, wherein the auxiliary electrodes are positioned such that a start discharge can be generated by a voltage induced in the auxiliary electrodes by a voltage applied to the discharge electrodes.

The lower and upper substrates can be glass substrates.

The auxiliary electrodes can be formed of ITO or SnO₂. The auxiliary electrodes can be formed of a material selected from a group consisting of RuO₂, Ag, Cu, and Cr.

The dielectric layer can be formed of a ferroelectric.

According to another aspect of the present invention, a flat lamp comprises a lower substrate and an upper substrate arranged to face each other and forming a discharge space therebetween, a plurality of discharge electrodes located on an outer surface of at least one of the lower and upper substrates, and a plurality of auxiliary electrodes locaed on an inner surface of a substrate where the discharge electrodes are located, and positioned such that a start discharge is generated by a voltage induced in the auxiliary electrodes by a voltage applied to the discharge electrodes.

A dielectric layer, in which the auxiliary electrodes are embedded, can be located on an inner surface of a substrate where the auxiliary electrodes are formed.

A trench can be located in the dielectric layer between the auxiliary electrodes.

The trench can be parallel to the auxiliary electrodes.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view illustrating part of a conventional flat lamp;

FIG. 2 is a sectional view illustrating part of a flat lamp according to an embodiment of the present invention;

FIG. 3 is a sectional view illustrating a modified example of the flat lamp of FIG. 2;

FIG. 4 is a sectional view illustrating another modified example of the flat lamp of FIG. 2;

FIG. 5 is a sectional view illustrating part of a flat lamp according to another embodiment of the present invention;

FIG. 6 is a sectional view illustrating part of a flat lamp according to yet another embodiment of the present invention;

FIG. 7 is a sectional view illustrating a modified example of the flat lamp of FIG. 6;

FIGS. 8A through 8C are views illustrating flat lamps used to compare the discharge voltage and luminance efficiency between the conventional flat lamp and the flat lamp according to the present invention;

FIG. 9 is a graph showing the results of comparison in the discharge voltage between the conventional flat lamp and the flat lamp according to the present invention; and

FIG. 10 is a graph showing the results of comparison in the luminance efficiency between the conventional flat lamp and the flat lamp according to the present invention.

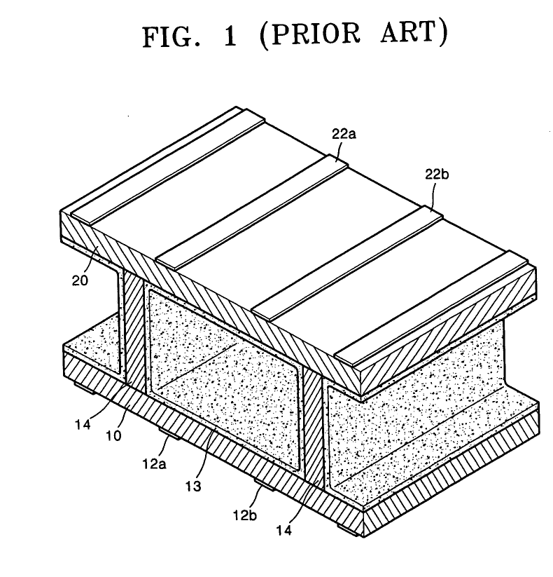

### DETAILED DESCRIPTION OF THE INVENTION

In the accompanying drawings, the same reference numerals indicate the same constituent elements.

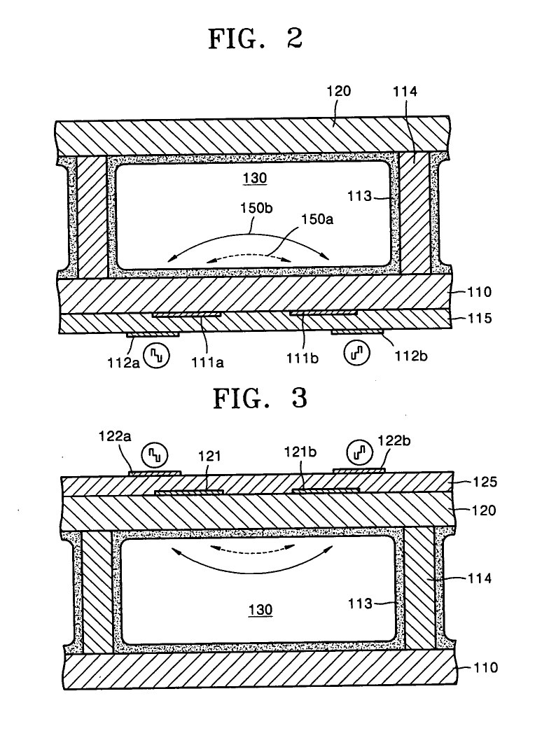

FIG. 2 is a sectional view illustrating part of a flat lamp according to an embodiment of the present invention. Referring to FIG. 2, a flat lamp according to an embodiment of the present invention includes a lower panel and an upper panel arranged to be separated from each other. A discharge space 130 where a plasma discharge is generated is formed between the lower panel and the upper panel. The discharge space 130 is filled with a discharge gas that is a mixture of neon (Ne) gas and xenon (Xe) gas.

The lower panel includes a lower substrate 110 and a dielectric layer 115 formed on a lower surface of the lower substrate 110. A glass substrate is generally used as the lower substrate 110. At least one pair of first and second electrodes 112a and 112b are formed on a lower surface of the dielectric layer 115, parallel to each other. The first and second electrodes 112a and 112b are discharge electrodes, to which a voltage in the form of pulses from a power source is applied, and formed of a conductive material.

In this embodiment, at least one pair of first and second auxiliary electrodes 111a and 111b are formed on a lower surface of the lower substrate 110, parallel to each other. The dielectric layer 115 is formed on the lower surface of the lower substrate 110 such that the first and second auxiliary electrodes 111a and 111b can be buried therein. The first and second auxiliary electrodes 111a and 111b correspond to the first and second electrodes 112a and 112b, respectively, and are formed in a direction parallel to the first and second electrodes 112a and 112b. The distance between the first and second auxiliary electrodes 111a and 111b is less than that between the first and second electrodes 112a and 112b. The first and second auxiliary electrodes 111a and 111b are floating electrodes, to which a voltage is induced via the dielectric layer 115 as a predetermined voltage is applied to the first and second electrodes 112a and 112b. The first and second auxiliary electrodes 111a and 111b may be formed of a transparent conductive material such as ITO (indium tin oxide) or SnO₂, or a conductive material such as RuO₂, Ag, Cu, or Cr. The same is true of first and second electrodes 122a and 122b. To reduce a voltage drop by the dielectric layer 115, the dielectric layer 115 may be formed of a material having a high dielectric constant. The dielectric layer 115 may be formed of a ferroelectric exhibiting a hysteresis property.

The upper panel includes an upper substrate 120 that is separated a predetermined distance from the lower substrate 110. A glass substrate is generally used as the upper substrate 120 like the lower substrate 110. A plurality of spacers 114 is provided between the lower substrate 110 and the upper substrate 120 to maintain a uniform distance therebetween. A fluorescent layer 113 for generating visible light by being exited by ultraviolet rays generated from the discharge gas by a plasma discharge is formed on portions constituting an interior wall of the discharge space 130, that is, inner surfaces of the lower substrate 110 and the upper substrate 120 and side surfaces of the spacers 114.

In the operation of the flat lamp configured as above, a voltage in the form of pulses is applied from the power source to the first and second electrodes 112a and 112b. When the pulse type voltage is applied to the first and second electrodes 112a and 112b, the voltage between the first and second electrodes 112a and 112b changes to reach a predetermined value. As the voltage between the first and second electrodes 112a and 112b changes, a voltage corresponding to the voltage between the first and second electrodes 112a and 112b is induced between the first and second auxiliary electrodes 111a and 111b via the dielectric layer 115. When the dielectric layer 115 is formed of a material having a high dielectric constant, since a voltage drop due to the dielectric layer 115 can be greatly reduced, the voltage that is substantially the same as that between the first and second electrodes 112a and 112b can be induced between the first and second auxiliary electrodes 111a and 111b. A start discharge 150a is primarily generated between the first and second auxiliary electrodes by the induced voltage. This is because the distance between the first and second auxiliary electrodes 111a and 111b is less than that between the first and second electrodes 112a and 112b. In the flat lamp according to the present embodiment, due to the first and second auxiliary electrodes 111a and 111b, the start discharge 150a is generated at a voltage lower than that of a conventional flat lamp.

Next, the voltage between the first and second electrodes 112a and 112b is maintained constantly after reaching a predetermined value. In this step, since the voltage between the first and second electrodes 112a and 112b does not change, the voltage is not induced in the first and second auxiliary electrodes 111a and 111b and a sustain discharge 150b is generated between the first and second electrodes 112a and 112b. Luminance efficiency can be improved by extending a discharge path by increasing the distance between the first and second electrodes 112a and 112b. Then, the start discharge 150a and the sustain discharge 150b are repeatedly generated in order in the discharge space 130.

FIG. 3 is a sectional view illustrating a modified example of the flat lamp of FIG. 2. Referring to FIG. 3, the upper panel includes the upper substrate 120 and a dielectric layer 125 formed on an upper surface of the upper substrate 120. The lower panel includes the lower substrate 110, arranged to be separated by a predetermined distance from the upper substrate 120.

At least one pair of first and second electrodes 122a and 122b are formed on an upper surface of the dielectric layer 125, parallel to each other. The first and second electrodes 122a and 122b are discharge electrodes, to which a voltage in the form of pulses is applied from the power source. At least one pair of first and second auxiliary electrodes 121a and 121b are formed on the upper surface of the upper substrate 120, parallel to each other. The dielectric layer 125 is formed on the upper surface of the upper substrate 120 such that the first and second auxiliary electrodes 121a and 121b can be buried therein. The first and second auxiliary electrodes 121a and 121b correspond to the first and second electrodes 122a and 122b, respectively, and are formed in a direction parallel to the first and second electrodes 122a and 122b. The first and second auxiliary electrodes 121a and 121b are formed such that the distance therebetween is less than that between the first and second electrodes 122a and 122b. The first and second auxiliary electrodes 121a and 121b are floating electrodes in which a voltage is induced via the dielectric layer 125 as a predetermined voltage is applied to the first and second electrodes 122a and 122b. The first and second auxiliary electrodes 121a and 121b may be formed of a transparent conductive material such as ITO and SnO₂ to transmit visible light. Alternatively, the first and second auxiliary electrodes 121a and 121b may be formed of a conductive material such as RuO₂, Ag, Cu, and Cr. The same is true of first and second electrodes 122a and 122b. The dielectric layer 125 may be formed of a material having a high dielectric constant or a ferroelectric having a hysterisis property.

Since the operation of the flat lamp having the above structure is the same as that described above, a detailed description thereof is omitted.

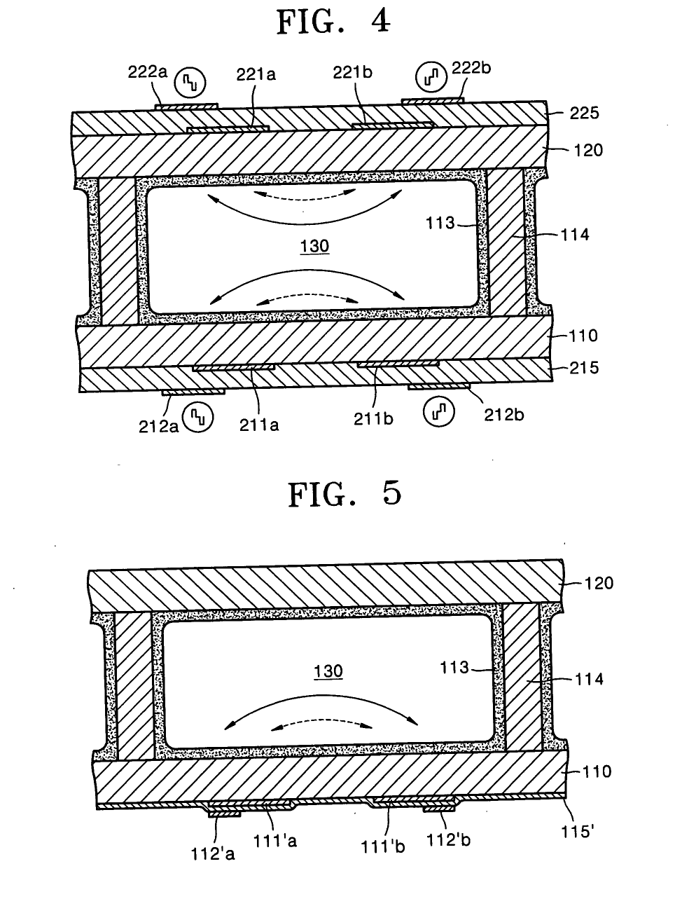

FIG. 4 is a sectional view illustrating another modified example of the flat lamp of FIG. 2. Referring to FIG. 4, the lower panel includes the lower substrate 110 and a first dielectric layer 215 formed on the lower surface of the lower substrate 110. The upper panel includes the upper substrate 120, arranged to be separated a predetermined distance from the lower substrate 110, and a second dielectric layer 225 formed on the upper surface of the upper substrate 120.

At least one pair of first and second lower electrodes 212a and 212b is formed on a lower surface of the first dielectric layer 215, parallel to each other. The first and second lower electrodes 212a and 212b are discharge electrodes, to which a voltage in the form of pulses is applied from the power source. At least one pair of first and second lower auxiliary electrodes 211a and 211b are formed on a lower surface of the lower substrate 110, parallel to each other. The first dielectric layer 215 is formed on the lower surface of the lower substrate 110 such that the first and second lower auxiliary electrodes 211a and 211b can be buried therein. The first and second lower auxiliary electrodes 211a and 211b correspond to the first and second lower electrodes 212a and 212b, respectively, and are formed in a direction parallel to the first and second lower electrodes 212a and 212b. The distance between the first and second lower auxiliary electrodes 211a and 211b is less than that between the first and second lower electrodes 212a and 212b. The first and second lower auxiliary electrodes 211a and 211b are floating electrodes, to which a voltage is induced via the first dielectric layer 215 as a predetermined voltage is applied to the first and second lower electrodes 212a and 212b. The first and second lower auxiliary electrodes 211a and 211b may be formed of a transparent conductive material such as ITO or SnO₂, or a conductive material such as RuO₂, Ag, Cu, or Cr. The same is true of first and second electrodes 122a and 122b. The first dielectric layer 215 may be formed of a material having a high dielectric constant, or a ferroelectric exhibiting a hysterisis property.

At least one pair of first and second upper electrodes 222a and 222b are formed on an upper surface of the second dielectric layer 225, parallel to each other. The first and second upper electrodes 222a and 222b are formed parallel to the first and second lower electrodes 212a and 212b. The first and second upper electrodes 222a and 222b are discharge electrodes, to which a voltage in the form of pulses is applied from the power source. At least one pair of first and second upper auxiliary electrodes 221a and 221b are formed on the upper surface of the upper substrate 120, parallel to each other. The second dielectric layer 225 is formed on the upper surface of the upper substrate 120 such that the first and second upper auxiliary electrodes 221a and 221b can be buried therein. The first and second upper auxiliary electrodes 221a and 221b correspond to the first and second electrodes 122a and 122b, respectively, and are formed in a direction parallel to the first and second upper electrodes 222a and 222b. The first and second upper auxiliary electrodes 221a and 221b are formed such that the distance therebetween is less than that between the first and second upper electrodes 222a and 222b. The first and second upper auxiliary electrodes 221a and 221b are floating electrodes in which a voltage is induced via the second dielectric layer 225 as a predetermined voltage is applied to the first and second upper electrodes 222a and 222b. The first and second upper auxiliary electrodes 221a and 221b may be formed of a transparent conductive material such as ITO and SnO₂ to transmit visible light. Alternatively, the first and second upper auxiliary electrodes 221a and 221b may be formed of a conductive material such as RuO₂, Ag, Cu, and Cr. The same is true of first and second electrodes 122a and 122b. The second dielectric layer 225 may be formed of a material having a high dielectric constant or a ferroelectric having a hysterisis property.

In the flat lamp configured as above, since the discharge electrodes, which are the first and second lower and upper electrodes 212a and 212b, and 222a and 222b, and the auxiliary electrodes, which are the first and second lower and upper auxiliary electrodes 211a and 211b, and 221a and 221b, are formed on both the lower and upper panels, the brightness and the luminance efficiency are further improved.

FIG. 5 is a sectional view illustrating part of a flat lamp according to another embodiment of the present invention. In the following description, only the differences from the above-described embodiments are described below.

Referring to FIG. 5, first and second auxiliary electrodes 111′a and 111′b generating a start discharge are formed on the lower surface of the lower substrate 110, parallel to each other. A dielectric layer 115′ is formed on the lower surface of the lower substrate 110 such that the first and second auxiliary electrodes 111′a and 111′b can be buried therein. The dielectric layer 115′ is formed thinner than in the above-described embodiments and formed of a material having a high dielectric constant. A pair of first and second electrodes 112′a and 112′b generating a sustain discharge are formed on the lower surface of the dielectric layer 115′a, parallel to each other. The distance between the first and second electrodes 112′a and 112′b is greater than that between the first and second auxiliary electrodes 111′a and 111′b. The areas where the first electrode 112′a overlaps the first auxiliary electrode 111′b and the second electrode 112′b overlaps the second auxiliary electrode 111′b are greater than those in the above-described embodiments.

When a material that is thin and has a high dielectric constant is used for the dielectric layer 115′ and the areas where the discharge electrodes, which are the first and second electrodes 112′a and 112′b, overlap the auxiliary electrodes, which are the first and second auxiliary electrodes 111′a and 111′b, increase, capacitance increases so that a voltage drop is further reduced compared to the above-described embodiments.

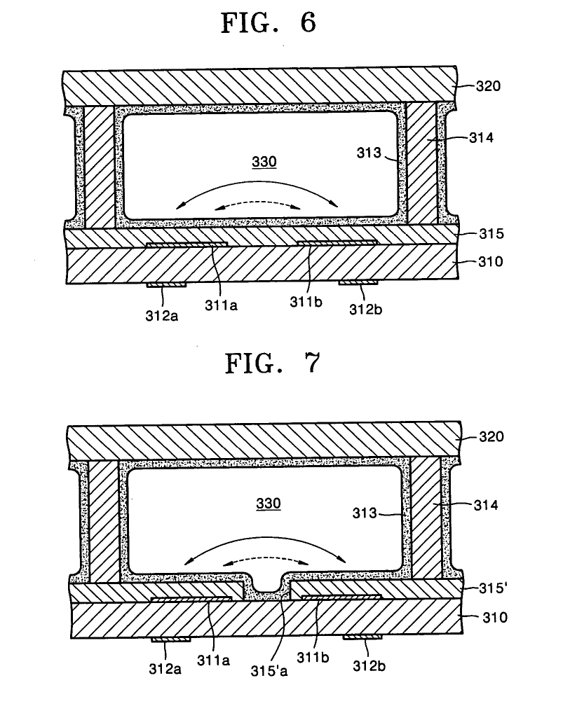

FIG. 6 is a sectional view illustrating part of a flat lamp according to yet another embodiment of the present invention. Referring to FIG. 6, a flat lamp according to the present embodiment includes a lower panel and an upper panel, which are arranged to be separated from each other. A discharge space 330 where a plasma discharge is generated is formed between the lower and upper panels. The discharge space 330 is filled with a discharge gas that is a mixture of neon (Ne) gas and xenon (Xe) gas.

The lower panel includes a lower substrate 310 and a dielectric layer 315 formed on a lower surface of the lower substrate 310. A glass substrate is generally used as the lower substrate 310. At least one pair of first and second electrodes 312a and 312b are formed on a lower surface of the lower substrate 310, parallel to each other. The first and second electrodes 312a and 312b are discharge electrodes, to which a voltage in the form of pulses from the power source is applied, and formed of a conductive material.

At least one pair of first and second auxiliary electrodes 311a and 311b are formed on an upper surface of the lower substrate 310, parallel to each other. The first and second auxiliary electrodes 311a and 311b correspond to the first and second electrodes 312a and 312b, respectively, and are formed in a direction parallel to the first and second electrodes 312a and 312b. The distance between the first and second auxiliary electrodes 311a and 311b is less than that between the first and second electrodes 312a and 312b. Unlike the auxiliary electrodes 111a and 111b of the embodiment shown in FIG. 2, outer edges of the auxiliary electrodes 311a and 311b of the embodiment of FIG. 6 may be substantially co-extensive with the outer edges of the discharge electrodes 312a and 312b, but are wider than the discharge electrodes 312a and 312b, such that the inner edges are closer together. Also, a dielectric layer 315 may be formed on the upper surface of the lower substrate 310 such that the first and second auxiliary electrodes 311a and 311b can be buried therein.

The first and second auxiliary electrodes 311a and 311b are floating electrodes, to which a voltage is applied via the lower substrate 310 that is a dielectric material as a predetermined voltage is induced to the first and second electrodes 312a and 312b. The first and second auxiliary electrodes 311a and 311b may be formed of a transparent conductive material such as ITO or SnO₂, or a conductive material such as RuO₂, Ag, Cu, or Cr. The same is true of first and second electrodes 122a and 122b.

The upper panel includes an upper substrate 320, which is separated a predetermined distance from the lower substrate 310. A glass substrate is generally used as the upper substrate 320 like the lower substrate 310. A plurality of spacers 314 is provided between the lower substrate 310 and the upper substrate 320 to maintain a uniform distance therebetween. A fluorescent layer 313 for generating visible light by being exited by ultraviolet rays generated from the discharge gas by a plasma discharge is formed on portions constituting an interior wall of the discharge space 330, that is, inner surfaces of the lower substrate 310 and the upper substrate 320 and side surfaces of the spacers 314.

Since the operation of the flat lamp configured as above is the same as that of the above-described embodiments, a detailed description thereof is omitted.

FIG. 7 is a sectional view illustrating a modified example of the flat lamp of FIG. 6. Referring to FIG. 7, a dielectric layer 315′ is formed on the upper surface of the lower substrate 310 such that the first and second auxiliary electrodes 311a and 311b can be buried therein. A trench 315′a having a predetermined shape to expose the lower substrate 310 is formed in the dielectric layer 315′ between the first and second auxiliary electrodes 311a and 311b. The trench 315′a is formed in a direction parallel to the first and second auxiliary electrodes 311a and 311b. Since not only a surface discharge but also a facing discharge can be generated by the trench 315′a when a discharge is generated between the first and second auxiliary electrodes 311a and 311b, a luminance efficiency is improved.

Although in the present embodiment the discharge electrodes and the auxiliary electrodes are described as being formed in the lower panel only, they can be formed on the upper panel or both the upper and lower panels.

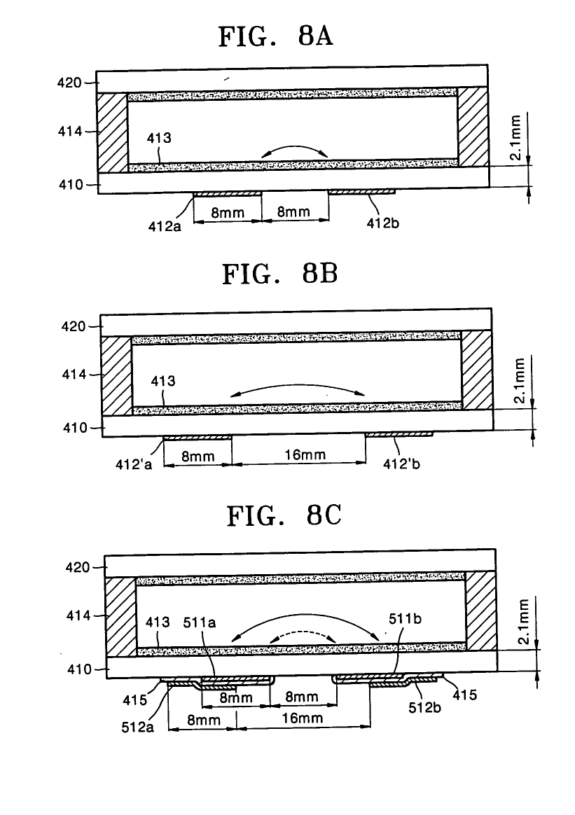

FIGS. 8A through 8C are views illustrating flat lamps used to compare the discharge voltage and luminance efficiency between the conventional flat lamp and the flat lamp according to the present invention. FIG. 8A shows a conventional flat lamp in which the distance between discharge electrodes 412a and 412b is 8 mm. FIG. 8B shows a conventional flat lamp in which the distance between discharge electrodes 412′a and 412′b is 16 mm. FIG. 8C shows a flat lamp according to an embodiment of the present invention in which the distances between discharge electrodes 512a and 512b and between auxiliary electrodes 511a and 511b, are 16 mm and 8 mm, respectively. In FIGS. 8A through 8C, copper tapes are used for the discharge electrodes and auxiliary electrodes. In FIG. 8C, an acetate tape having a dielectric constant of about 2-3 is used as a dielectric layer 415 formed between the discharge electrodes 512a and 512b and auxiliary electrodes 511a and 511b. In FIGS. 8A through 8C, reference numerals 410, 413, 414, and 420 denote a lower substrate, a fluorescent layer, a spacer, and an upper substrate.

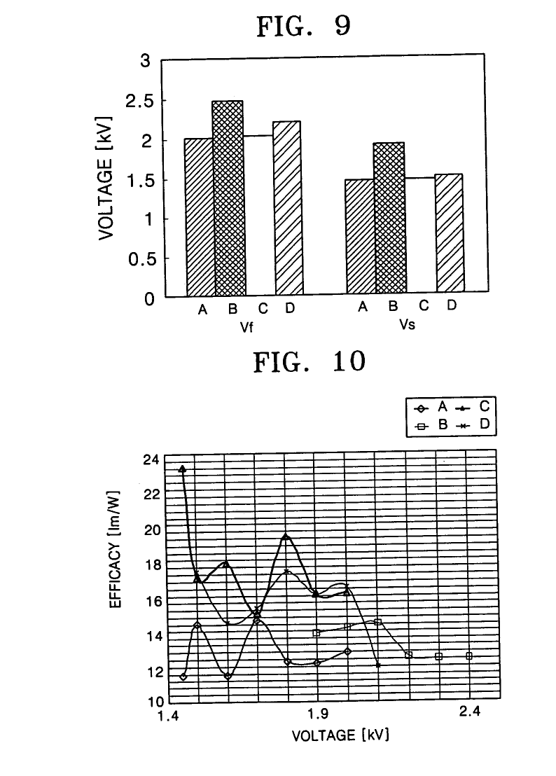

FIGS. 9 and 10 are graphs showing the results of the discharge voltage and the luminance efficiency of the flat lamps shown in FIGS. 8 through 8C. FIGS. 9 and 10 show the results measured when a voltage in the form of pulses having a frequency of 20 KHz and a duty ratio of 20% is applied to the discharge electrodes. Here, A and B denote the flat lamp shown in FIGS. 8A and 8B, respectively, and C and D indicate cases in which the thickness of the dielectric layer of the flat lamp shown in FIG. 8C is 40 μm and 120 μm, respectively.

FIG. 9 shows a discharge start voltage Vf and a discharge sustain voltage Vs. Referring to FIG. 9, the discharge start voltage Vf is 2.48 KV in the conventional flat lamp (case B) in which the distance between the discharge electrodes 412′a and 412′b is large. The discharge start voltage Vf is 2.03 kV for the flat lamp (case C) according to the present invention. Thus, it can be seen that the discharge start voltage Vf of the flat lamp (case C) according to the present invention is lowered by about 18% compared to the conventional flat lamp (case B). While the discharge sustain voltage Vs is 1.90 kV in the conventional flat lamp (case B) in which the distance between the discharge electrodes 412′a and 412′b is large, the discharge sustain voltage Vs of the flat lamp (case C) according to the present invention is 1.46 kV. Thus, it can be seen that the discharge sustain voltage Vs of the flat lamp (case C) according to the present invention is lowered by about 23% compared to the conventional flat lamp (case B).

FIG. 10 shows the results of comparison in the luminance efficiency between the conventional flat lamp and the flat lamp according to the present invention. Referring to FIG. 10, while the luminance efficiency is 14.21 lm/W in the conventional flat lamp (case B) in which the distance between the discharge electrodes 412′a and 412′b is large, the luminance efficiency of the flat lamp (case C) according to the present invention is 17.9 lm/W. Thus, it can be seen that the luminance efficiency of the flat lamp (case C) according to the present invention is improved by about 26% compared to the conventional flat lamp (case B).

As described above, in the flat lamp according to the present invention, since the auxiliary electrodes in which the voltage is induced as the voltage is applied to the discharge electrodes is formed at least one of the upper and lower substrates, the discharge voltage is lowered and the luminance efficiency is improved, compared to the conventional flat lamp.

Also, when the range of the discharge voltage applied to the flat lamp according to the present invention and the conventional flat lamp is the same, since a more amount of xenon (Xe) gas can be applied in the flat lamp according to the present invention than in the conventional flat lamp, the luminance efficiency can be further improved.

While this invention has been particularly shown and described with reference to preferred embodiments thereof, it will be understood by those skilled in the art that various changes in form and details may be made therein without departing from the spirit and scope of the invention as defined by the appended claims. For instance, the auxiliary electrodes and discharge electrodes are shown as being layered on a surface of the substrates, but it should be recognized that the phrase “on the substrates” includes embodiments where the electrodes are embedded in the substrates.

What is claimed is:

1. A flat lamp comprising:
a lower panel and an upper panel arranged to face each other and forming a discharge space therebetween;
a plurality of discharge electrodes located on at least one of the lower and upper panels; and
a plurality of auxiliary electrodes located on a panel where the discharge electrodes are located and positioned such that a start discharge is generated by a voltage induced in the auxiliary electrodes by a voltage applied to the discharge electrodes.

2. The flat lamp as claimed in claim 1, wherein a dielectric layer is formed between the discharge electrodes and the auxiliary electrodes.

3. The flat lamp as claimed in claim 1, wherein the discharge electrodes are formed in pairs parallel to each other and the auxiliary electrodes are formed in pairs parallel to each other and corresponding to the discharge electrodes.

4. The flat lamp as claimed in claim 3, wherein the auxiliary electrodes are formed in a direction parallel to the discharge electrodes.

5. The flat lamp as claimed in claim 4, wherein a distance between the auxiliary electrodes is less than a distance between the discharge electrodes.

6. A flat lamp comprising:
a lower substrate and an upper substrate arranged to face each other and forming a discharge space therebetween;
a dielectric layer located on an outer surface of at least one of the lower and upper substrates;
a plurality of discharge electrodes located on a surface of the dielectric layer; and
a plurality of auxiliary electrodes located on the outer surface of a substrate where the discharge electrodes are located and embedded in the dielectric layer, and wherein the auxiliary electrodes are positioned such that a start discharge is generated by a voltage induced in the auxiliary electrodes by a voltage applied to the discharge electrodes.

7. The flat lamp as claimed in claim 6, wherein the discharge electrodes are formed in pairs parallel to each other and the auxiliary electrodes are formed in pairs parallel to each other and corresponding to the discharge electrodes.

8. The flat lamp as claimed in claim 7, wherein the auxiliary electrodes are formed in a direction parallel to the discharge electrodes.

9. The flat lamp as claimed in claim 8, wherein a distance between the auxiliary electrodes is less than a distance between the discharge electrodes.

10. The flat lamp as claimed in claim 6, wherein the lower and upper substrates are glass substrates.

11. The flat lamp as claimed in claim 6, wherein the auxiliary electrodes are formed of a transparent conductive material.

12. The flat lamp as claimed in claim 11, wherein the auxiliary electrodes are formed of ITO or SnO₂.

13. The flat lamp as claimed in claim 6, wherein the auxiliary electrodes are formed of a material selected from a group consisting of RuO₂, Ag, Cu, and Cr.

14. The flat lamp as claimed in claim 6, wherein the dielectric layer is formed of a ferroelectric.

15. A flat lamp comprising:
a lower substrate and an upper substrate arranged to face each other and forming a discharge space therebetween;
a plurality of discharge electrodes located on an outer surface of at least one of the lower and upper substrates; and
a plurality of auxiliary electrodes located on an inner surface of a substrate on which the discharge electrodes are located, and positioned such that a start discharge is generated by a voltage induced in the auxiliary electrodes by a voltage applied to the discharge electrodes.

16. The flat lamp as claimed in claim 15, wherein the discharge electrodes are formed in pairs parallel to each other and the auxiliary electrodes are formed in pairs parallel to each other and corresponding to the discharge electrodes.

17. The flat lamp as claimed in claim 16, wherein the auxiliary electrodes are formed in a direction parallel to the discharge electrodes.

18. The flat lamp as claimed in claim 17, wherein a distance between the auxiliary electrodes is less than a distance between the discharge electrodes.

19. The flat lamp as claimed in claim 15, wherein a dielectric layer in which the auxiliary electrodes are embedded is formed on an inner surface of a substrate where the auxiliary electrodes are located.

20. The flat lamp as claimed in claim 19, wherein the lower and upper substrates are glass substrates.

21. The flat lamp as claimed in claim 15, wherein the auxiliary electrodes are formed of a transparent conductive material.

22. The flat lamp as claimed in claim 21, wherein the auxiliary electrodes are formed of ITO or SnO₂.

23. The flat lamp as claimed in claim 15, wherein the auxiliary electrodes are formed of a material selected from a group consisting of RuO₂, Ag, Cu, and Cr.

24. A flat lamp comprising:
a lower substrate and an upper substrate arranged to face each other and forming a discharge space therebetween;
a plurality of discharge electrodes located on a surface of at least one of the lower and upper substrates; and
a plurality of auxiliary electrodes located on an inner surface of a substrate on which the discharge electrodes are located, and positioned such that a start discharge is generated by a voltage induced in the auxiliary electrodes by a voltage applied to the discharge electrodes, wherein a trench is formed in the dielectric layer between the auxiliary electrodes.

25. The flat lamp as claimed in claim 24, wherein the trench is parallel to the auxiliary electrodes.
